(19) United States
(12) Patent Application Publication
(10) Pub. No.: US 2011/0242699 A1
(43) Pub. Date: Oct. 6, 2011

(54) HARD DISK CONTROL MODULE, APPARATUSES HAVING THE SAME, AND METHOD OF CONTROLLING UNLOAD STANDBY TIME THEREOF

(75) Inventors: Jae Chul SHIM, Hwaseong-si (KR); Hae June Lee, Suwon-si (KR)

(73) Assignee: Samsung Electronics Co., Ltd, Suwon-si (KR)

(21) Appl. No.: 13/079,953

(22) Filed: Apr. 5, 2011

(30) Foreign Application Priority Data
Apr. 5, 2010 (KR) 10-2010-0030760

(51) Int. Cl. G11B 21/02

(52) U.S. Cl. 360/75; G9B/21.003

(57) ABSTRACT

A hard disk control module includes a load/unload counter and a controller. The load/unload counter counts a number of loads/unloads of a head on/from a surface of a disk. The controller may determine the number of counted loads/unloads during a reference time. The controller controls an unload standby time of the head according to a load/unload count value and the reference time.

### CROSS-REFERENCE TO RELATED APPLICATIONS

This application claims priority under 35 U.S.C. §119(a) from Korean Patent Application No. 10-2010-0030760 filed on Apr. 5, 2010, the disclosure of which is hereby incorporated by reference in its entirety.

### BACKGROUND

1. Field of the Invention

The present general inventive concept relates to a technology to control an unload standby time of a magnetic head, and more particularly, to a hard disk control module to count the number of loads/unloads of a magnetic head and controlling an unload standby time of the magnetic head according to a load/unload count value, apparatuses having the hard disk control module, and a method of controlling an unload standby time of the hard disk control module.

2. Description of the Related Art

Hard disk drives (HDDs) are recording apparatuses used to store information. Information is usually written to a concentric track formed on a surface of a magnetic disk. A magnetic disk is rotatably mounted on a spindle motor. The information written to the magnetic disk is accessed by a magnetic head mounted on an actuator arm rotated by a voice coil motor (VCM). The VCM is magnetized by current and rotates the actuator arm and moves the magnetic head. The magnetic head detects a change in magnetism of a surface of the magnetic disk and reads the information written to the surface of the magnetic disk.

The HDD reads or writes data in response to a command output from a host. The HDD unloads i.e., parks, the magnetic head in a standby position for a predetermine standby time to save power consumption when in an idle state, that is, a state of waiting for a command to be output from the host without carrying out any particular action, continues over a predetermined time.

### SUMMARY

The present general inventive concept provides a hard disk control module to count the frequency of loads/unloads of a magnetic head and controlling an unload standby time of the magnetic head according to a load/unload count value, apparatuses having the hard disk control module, and a method of controlling an unload standby time of the hard disk control module.

Additional features and utilities of the present general inventive concept will be set forth in part in the description which follows and, in part, will be obvious from the description, or may be learned by practice of the present general inventive concept.

According to a feature of the present general inventive concept, there is provided a hard disk control module including a load/unload counter to count a frequency of loads/unloads of a head on/from a surface of a disk, and a controller to control an unload standby time of the head according to a load/unload count value for a reference time.

When the load/unload count value is equal to or greater than a reference count value, the controller may stop a load/unload operation of the head.

The controller may compare the load/unload count value with a reference count value and control the unload standby time according to a result of the comparison.

According to another feature of the present general inventive concept, there is provided a hard disk drive including a hard disk, a head, a voice coil motor to control an operation of the head, and a voice coil motor driver to control an operation of the voice coil motor according to the unload standby time controlled by the controller of the hard disk control module.

According to another feature of the present general inventive concept, there is provided a computer system including the hard disk drive and a host to control an operation of the hard disk drive.

According to still another feature of the present general inventive concept, there is provided a method of controlling an unload standby time of a hard disk control module, the method including setting a reference time to count a frequency of loads/unloads of a head on/from a surface of a disk, counting the frequency of loads/unloads of the head for the reference time, and controlling an unload standby time of the head according to a load/unload count value.

In the controlling of an unload standby time of the head, when the load/unload count value is equal to or greater than a reference count value, a load/unload operation of the head may be stopped.

The controlling of an unload standby time of the head may include comparing the load/unload count value with a reference count value, and controlling the unload standby time according to a result of the comparison.

According to another feature of the present general inventive concept, there is provided a disk controller including a load/unload counter to measure a time interval during which a load/unload is generated whenever the load/unload of a head is generated for a reference time, a load/unload counter to count a frequency of loads/unloads according to a measured time interval, and a controller for setting a first time interval having a first value and a second time interval having a second value, of load/unload count values counted for each time interval, and determining an unload standby time using the determined first and second time intervals.

The first value may be the largest load/unload count value of the counted load/unload count values and the second value may be the largest value next to the first value, and the controller may determine the unload standby time existing between the first and second time intervals.

According to another feature of the present general inventive concept, there is provided a hard disk drive including a hard disk, a head, a voice coil motor to control an operation of the head, and a voice coil motor driver to control an operation of the voice coil motor according to the unload standby time controlled by the controller of the hard disk control module.

The controller may determine a first time interval having a first value and a second time interval having a second value, of load/unload count values counted for each time interval, and determine an unload standby time existing between the first and second time intervals.

According to yet another feature of the present general inventive concept, there is provided a computer system including the hard disk drive, and a host to control an operation of the hard disk drive.

According to another feature of the present general inventive concept, there is provided a method of controlling an unload standby time of a hard disk control module, the method including setting a reference time to count a number of loads/unloads of a head on/from a surface of a disk, measuring a time interval during which a load/unload occurs whenever the load/unload of the head occurs for the reference time, and counting the number of loads/unloads according to a measured time interval, and determining a first time interval having a first value and a second time interval having a second value, of load/unload count values according to the time interval, and determining the unload standby time using the determined first and second time intervals.

The first value may be the largest load/unload count value of the load/unload count values and the second value may be the largest load/unload count value next to the first value, and, the unload standby time is exists between the first and second time intervals.

According to another feature of the present general inventive concept, a hard disk drive (HDD), comprising a VCM module to perform loading of at least one head on at least one disk and to perform unloading of the at least one head from the at least one disk to position the at least one head into a standby position, and a load/unload module to detect the loading and the unloading of the at least one head and to adjust a standby time corresponding to the standby position based on a total count value including at least one of a total number of loadings and a total number of unloadings.

Accordingly to yet another feature of the present general inventive concept, a method of controlling an unload standby time of at least one head included in a hard disk drive (HDD), the method comprising, detecting loading of the at least one head on a corresponding disk and detecting unloading of the at least one head from the disk and into a standby position, determining a total count value including at least one of a total number of the detected loadings and a total number of the detected unloadings, increasing the unload standby time when the total count value at least one of equals and exceeds a predetermined threshold value, and decreasing the unload standby time when the total count value is below the predetermined threshold value.

### BRIEF DESCRIPTION OF THE DRAWINGS

The above and/or other features of the present general inventive concept will become apparent and more readily appreciated from the following description of the exemplary embodiments, taken in conjunction with the accompanying drawings, in which:

FIG. 1 is a block diagram of an HDD according to an exemplary embodiment of the present general inventive concept;

FIG. 2 is a block diagram of a hard disk control module of FIG. 1;

FIG. 3 is a flowchart illustrating a method of controlling an unload standby time of a hard disk control module according to an exemplary embodiment of the present general inventive concept;

FIG. 4 is a flowchart illustrating a method of controlling an unload standby time of a hard disk control module according to another exemplary embodiment of the present general inventive concept; and

FIG. 5 is a flowchart illustrating a method of controlling an unload standby time of a hard disk control module according to yet another exemplary embodiment of the present general inventive concept;

FIG. 6 is a graph showing the number of loads/unloads according to each time interval according to an exemplary embodiment of the present general inventive concept; and

FIG. 7 is a block diagram of a computer system including the HDD of FIG. 1.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

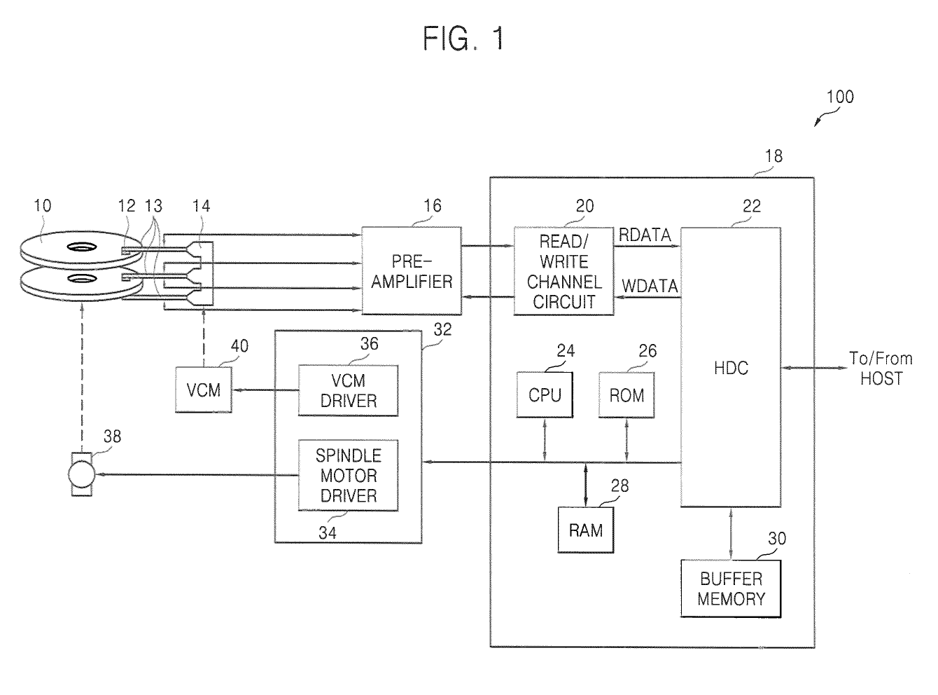

FIG. 1 is a block diagram of a hard disk drive (HDD) 100 according to an exemplary embodiment of the present general inventive concept. Referring to FIG. 1, the HDD 100 includes a plurality of hard disks 10 that are magnetic recording media, a plurality of heads 12, a head assembly 14, a pre-amplifier 16, a circuit block 18, a servo control block 32, a spindle motor 38, and a voice coil motor (VCM) 40.

Each of the hard disks 10 may store data and be rotated by the spindle motor 38. Each of the heads 12 is located over a corresponding one of the hard disks 10 and performs a read and/or write operation. Each of the heads 12 is installed on a corresponding support arm 13 coupled to the VCM 40, and extending from the head assembly 14 toward the hard disks 10.

When data stored in the hard disks 10 is read, the pre-amplifier 16 amplifies a read signal output by any one of the heads 12 and outputs an amplified read signal to a read/write channel circuit 20, When data is written to the hard disks 10, the pre-amplifier 16 transmits a write signal output from the read/write channel circuit 20, for example, a write current, to any one of the heads 12. Thus, the heads 12 may write the write signal to any one of the disks 10.

The read/write channel circuit 20 converts the read signal amplified by the pre-amplifier 16 to read data RDATA and outputs the RDATA to a hard disk control module (HDC) 22. Also, the read/write channel circuit 20 converts write data WDATA output from the hard disk control module (HDC) 22 to a write signal and outputs the write signal to the pre-amplifier 16.

More specifically, the HDC 22 may be in communication with a host 210. When data is written to the hard disks 10, the HDC 22 outputs the WDATA output from a host (not shown) to the read/write channel circuit 20 under the control of a central processing unit (CPU) 24. Accordingly, the WDATA output from the host may be written to any one of the hard disks 10 via the read/write channel circuit 20, the pre-amplifier 16, and a corresponding one of the heads 12.

When data is read from the hard disks 10, the HDC 22 may receive RDATA decoded by the read/write channel circuit 20 and transmit received RDATA to the host via an interface (not shown), under the control of the CPU 24. Additionally, the HDC 22 may count the number (or frequency) of loads/unloads of each of the heads 12 on/from a surface of the hard disks 10 and control an unload standby time of each of the heads 12 according to a load/unload count value, as discussed in greater detail below. Accordingly, the standby time during which the heads 12 are maintained in the standby position can be optimized based on how often the heads 12 of the HDD 100 are loaded/unloaded, i.e., the frequency of loads/unloads of each of the heads 12.

The CPU 24 may read a control code or boot code stored in a read only memory (ROM) 26 and store the control code or the boot code in a random access memory (RAM) 28. The CPU 24 may generally control the operation of the HDD 100 or the HDC 22 based on the control code or boot code stored in the RAM 28. Thus, the CPU 24 may control the read or write operation of the HDD 100, The CPU 24 may receive a read or write command output from the host via the interface connected to a bus (not shown). To control track seek or track following according to a received command, the CPU 24 may control the operation of a servo controller (not shown) to control a spindle motor driver 34 and a VCM driver 36,

The spindle motor driver 34 controls the operation of the spindle motor 38 to control rotation of each of the hard disks 10, in response to a spindle control signal output from the HDC 22. Additionally, the HDC may output a VCM control signal to control operation of the VCM driver 36. The VCM driver 36 generates a driving current to drive the VCM 40 and outputs the driving current to a voice coil of the VCM 40, in response to a control signal to control the position of each of the heads 12 output from the HDC 22.

Thus, the VCM 40 moves one of the heads 12 to a track formed on a corresponding one of the disks 10 where data to read is written, according to the direction and level of the driving current output from the VCM driver 36. The head 12 moved by the VCM 40 outputs position information written to the hard disks 10 to the pre-amplifier 16 according to a control signal output from the read/write channel circuit 20 or under the control of the HDC 22.

When the head 12 is moved to a target track of the hard disks 10 to read, a disc formatter (not shown) of the HDC 22 outputs a servo gate signal to the read/write channel circuit 20. The read/write channel circuit 20 reads a servo pattern written to the hard disks 10 in response to the servo gate signal.

A buffer memory 30 may temporarily store data exchanged between the HDD 100 and the host. According to another exemplary embodiment, the buffer memory 30 may be embodied outside the circuit block 18.

According to an exemplary embodiment, the circuit block 18 including the read/write channel circuit 20, the HDC 22, the CPU 24, the ROM 26, and the RAM 28 may be embodied in a single chip, for example, a system on chip (SoC). Also, the motor control block 32 including the spindle motor driver 34 and the VCM driver 36 may be embodied in a single chip, for example, a SoC.

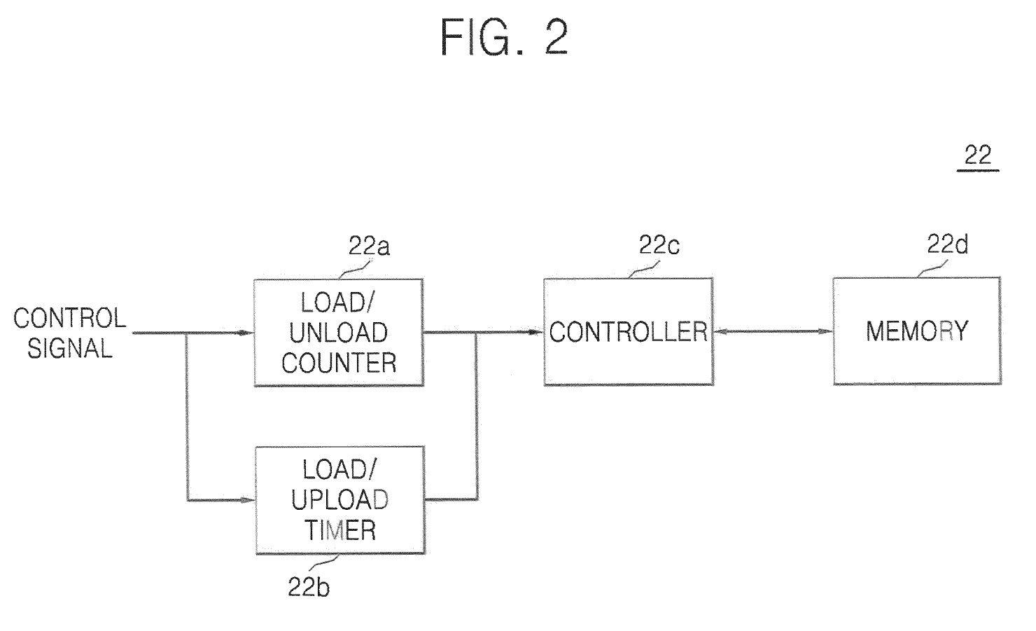

FIG. 2 is a block diagram of a hard disk control module of FIG. 1. Referring to FIG. 2, the hard disk control module (HDC) 22 includes a load/unload counter 22a and a controller 22c. According to another exemplary embodiment, the HDC 22 may further include at least one of a load/unload counter 22a or a memory 22d.

The load/unload counter 22a counts the number of loads/unloads of the heads 12 on/from surfaces of the disks 10 of the HDD 100. More specifically, the host 210 and HDC 22 communicate with each other to load/unload the heads 12 on/from surfaces of the disks 10. The host outputs a load control signal to initiate the process of loading the heads 12. When the HDC 22 receives the load control signal, the HDC 22 outputs the VCM control signal to control the VCM driver 36, and ultimately load the heads 12 on the disks 10. On the other hand, when the heads 12 have completed reading and/or writing data to/from the disks 10, the HDC may output an unload control signal to initiate the process of unloading the heads 12 from the disks 10, and parking the heads 12 in a standby position. Based on the load and/or unload control signal received or output, respectively, by the HDC, the load/unload counter 22a counts the number of loads and/or unloads of the heads 12 that is loaded or unloaded.

The load/unload counter 22a outputs a counted load/unload count value to the controller 22c. The load/unload count value counted by the load/unload counter 22a may be stored in the memory 22d under the control of the controller 22c, The memory 22d may be at least a part of the ROM 26 or the RAM 28.

According to another exemplary embodiment, the load/unload counter 22a may count the number of loads/unloads according to each time interval during which loads/unloads occur. More specifically, a load/unload timer 22b may measure a time interval during which loads/unloads occur whenever loads/unloads of the heads 12 on/from the surfaces of the disks 10 occur for a predetermined time period. Also, the load/unload timer 22b may operate as a timer with respect to a reference time to count the number of loads/unloads of the heads 12. That is, when a reference time is reached while the load/unload counter 22a counts the frequency of loads/unloads of the heads 12, the load/unload timer 22b may transmit a signal indicating that the reference time is reached to the controller 22c.

The controller 22c may control an unload standby time of the heads 12 according to a load/unload count value counted by the counter 22a for the reference time. The controller 22c may compare the count value counted by the load/unload counter 22a with a reference count value and control an unload standby time according to a result of the comparison, The controller 22c may stop the operation of the heads 12 when the count value is equal to or greater than the reference count value.

According to an exemplary embodiment, the controller 22c may control an unload standby time using the number of loads/unloads according to each time interval during which the loads/unloads counted by the load/unload counter 22a occur. For example, the load/unload counter 22a may count “70” as the number of loads/unloads of the heads 12 having a time interval of “10” seconds or “100” as the number of loads/unloads of the heads 12 having a time interval of “5” seconds.

The controller 22c may determine a first time interval and a second time interval respectively having a first value and a second value of the load/unload frequency according to each time interval counted by the load/unload counter 22a, The controller 22c may control an upload standby time by using the first and second time intervals. The first value is the largest one of the count values of the load/unload number according to each time interval. The second value is the largest count value next to the first value. The controller 22c may determine an unload standby time existing between the first and second time intervals.

The memory 22d may store the load/unload count value counted by the load/unload counter 22a, Also, the memory 22d stores a reference time and a reference count value. The memory 22d may be embodied by a volatile memory or a non-volatile memory.

According to another embodiment, the memory 22d stores the time intervals during which loads/unloads occur and which is measured by a load/unload timer 22b. Also, the memory 22d may store a load/unload count value according to each of the time interval counted by the load/unload counter 22a. Although FIG. 2 illustrates that the HDC 22 includes the memory 22d, the memory 22d may be embodied outside the HDC 22 like the ROM 26 or the RAM 28.

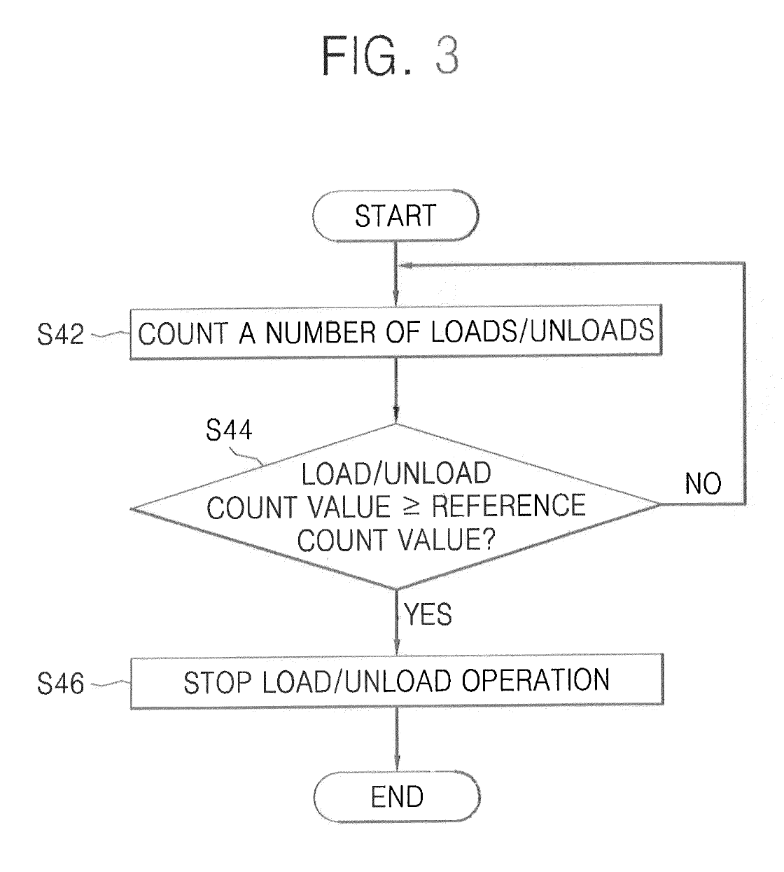

FIG. 3 is a flowchart illustrating a method of controlling an unload standby time of a hard disk control module according to an exemplary embodiment of the present general inventive concept. Referring to FIGS. 1-3, when the load/unload counter 22a counts the number of loads/unloads of the heads 12 (S42), the controller 22c determines whether the load/unload count value counted by the load/unload counter 22a is equal to or greater than a reference count value (S44). The reference count value may be previously stored in the memory 22d. The controller 22c may also control the load/unload counter 22a to count the number of loads/unloads of the heads 12 for a reference time previously stored in the memory 22d.

When the load/unload count value counted by the load/unload counter 22a for a reference time is less than a reference count value (S44), the controller 22c controls the load/unload counter 22a to continue counting the number of loads/unloads of the heads 12 (S42). When the load/unload count value counted by the load/unload counter 22a for the reference time is equal to or greater than the reference count value (S44), the controller 22c may stop the load/unload operation of the heads 12 (S46). According to another exemplary embodiment, the controller 22c may stop the unload operation of the heads 12 and control the HDD 100 to maintain a state that the heads 12 are loaded on the surfaces of the disks 10.

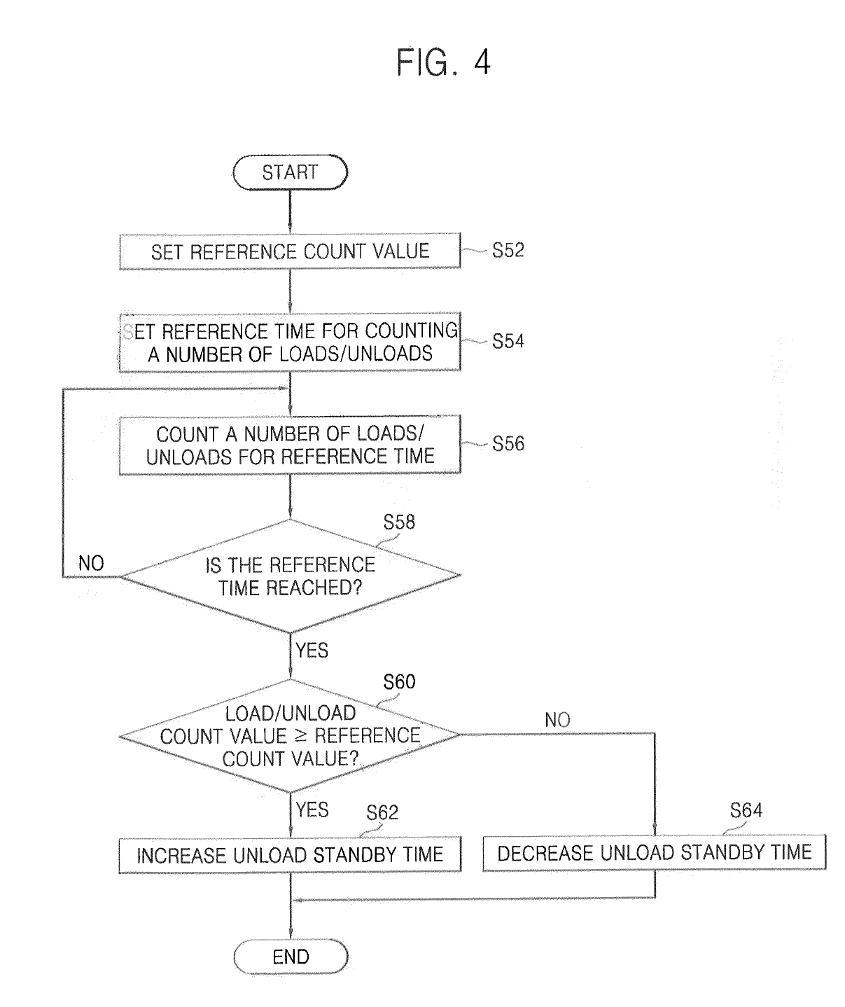

FIG. 4 is a flowchart illustrating a method of controlling an unload standby time of a hard disk control module according to another exemplary embodiment of the present general inventive concept. Referring to FIG. 4, the controller 22c sets a reference count value (S52). The controller 22c sets a reference time to count the number of loads/unloads of the heads 12 (S54). The load/unload counter 22a counts the number of loads/unloads of the heads 12 during the reference time (S56). A load/unloads count value counted by the load/unload counter 22a may be output to the controller 22c.

The controller 22c determines whether a time during which the load/unload counter 22a counts the number of loads/unloads of the heads 12 reaches the reference time (S58). When the count time is not reached the reference time (S58), the controller 22c controls the load/unload counter 22a to continue counting the number of loads/unloads until the reference time is reached (S54).

However, when the count time reaches the reference time (S58), the controller 22c determines whether the load/unloads count value output by the load/unload counter 22a is equal to or greater than the reference count value (S60). When the load/unloads count value is equal to or greater than the reference count value (S60), the controller 22c increases an unload standby time of the heads 12 (S62). For example, when the unload standby time of the heads 12 is 5 seconds, the controller 22c may increase the unload standby time from 5 seconds to 10 seconds.

However, when the load/unloads count value is less than the reference count value (S60), the controller 22c decreases the unload standby time of the heads 12 (S64). For example, when the unload standby time of the heads 12 is 30 seconds, the controller 22c may decrease the unload standby time from 30 seconds to 25 seconds.

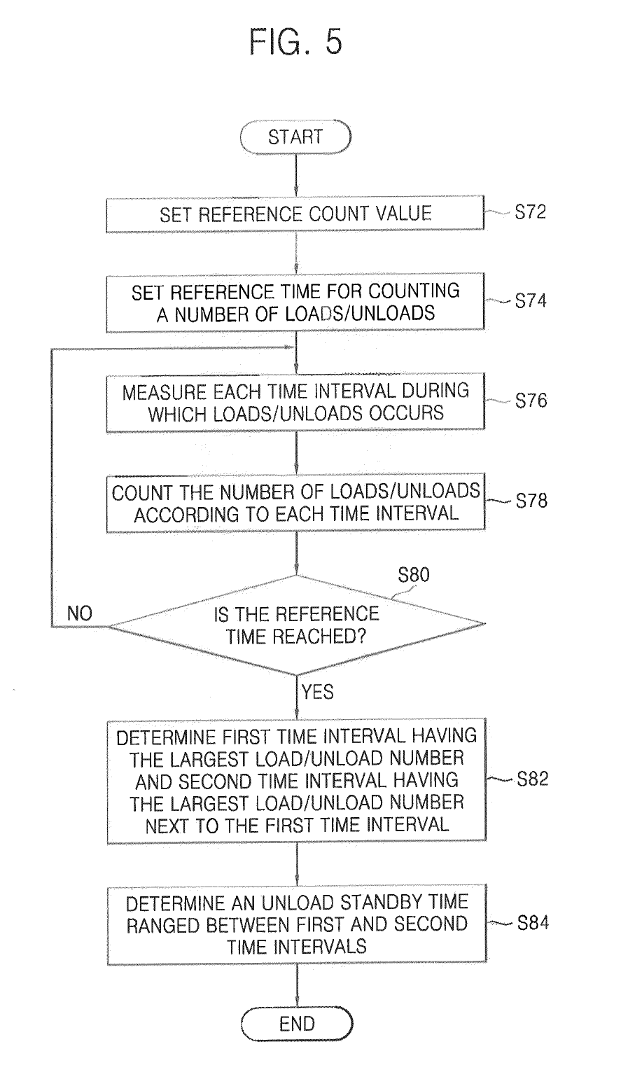

FIG. 5 is a flowchart illustrating a method of controlling an unload standby time of a hard disk control module according to another exemplary embodiment of the present general inventive concept. Referring to FIG. 5, the controller 22c sets a reference count value (S72). The controller 22c also sets a reference time during which the number of loads/unloads are counted (S74). The reference count value and the reference time set by the controller 22c may be previously stored in the memory 22d.

Whenever a load/unload occurs, the load/unload timer 22b measures each time interval during which the load/unload occurs (S76). Also, the load/unload counter 22a counts the number of loads/unloads according to each time interval (S78). The load/unload operation of the heads 12 may be performed when the heads 12 receive a control signal from the host or the controller 22c.

When the load/unload counter 22a counts the number of loads/unloads during each time interval, the controller 22c determines whether to reach the reference time (S80). When the reference time is not reached (S80), the controller 22c may control the load/unload counter 22a and the load/unload timer 22b to repeat the operations S76 and S78 until the reference time is reached.

When the reference time is reached (S80), the controller 22c determines a first time interval having the largest load/unload number and a second time interval having the largest load/unload number next to the first time interval (S82). The controller 22c may determine the first and second time intervals using the number of loads/unloads during each time interval counted in the operation S78.

When the first and second time intervals are determined, the controller 22c determines an unload standby time of the heads 12 that exists in a range between the first and second time intervals (S84). For example, when the first and second time intervals are 10 seconds and 50 seconds, respectively, the controller 22c may determine the unload standby time ranged between 10 to 50 seconds.

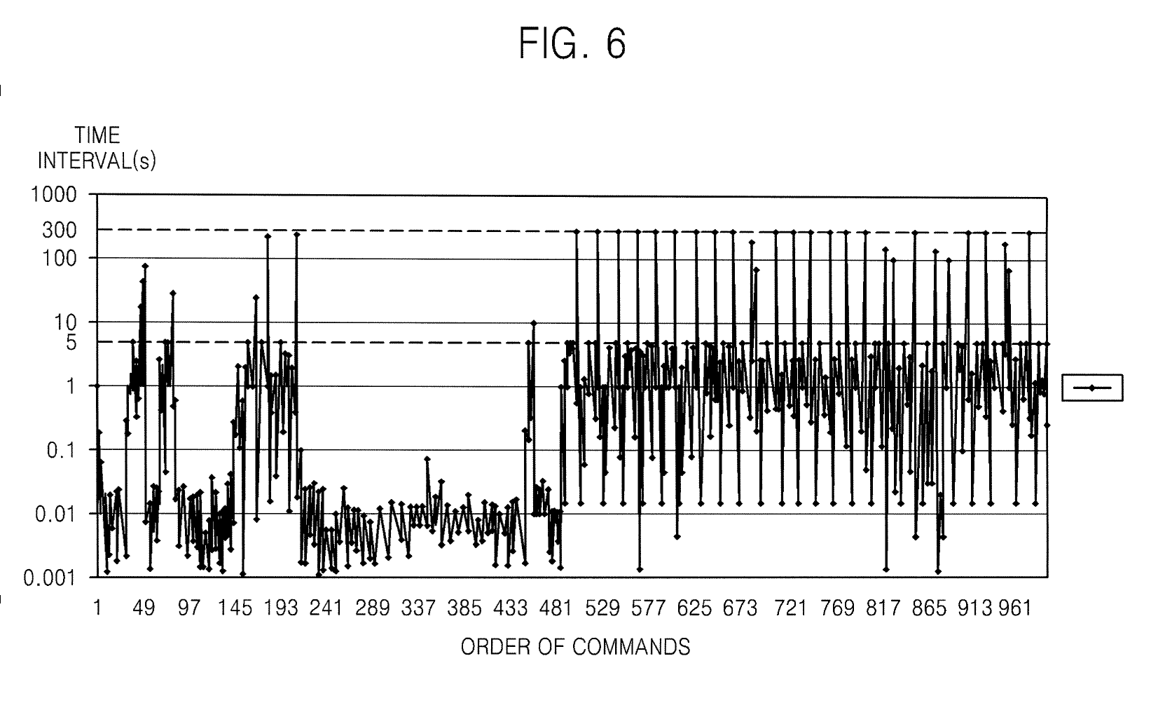

FIG. 6 is a graph showing the number of loads/unloads according to each time interval according to an exemplary embodiment of the present general inventive concept. Referring to FIG. 6, an X-axis denotes the order of commands transferred to the HDD 100, that is, the order of commands output from the host or the HDC 22 and occurred to load the heads 12. Also, a Y-axis denotes an interval of generation between a present command and a previous command, for example, a time interval during which load/unload operations of the heads 12 occur. As illustrated in FIG. 6, it can be seen that the 200^{th} command is generated 300 seconds after the 199^{th} command is generated.

As illustrated in FIG. 6, when the first time interval is 5 seconds and the second time interval is 300 seconds, the controller 22c determines an unload standby time of the heads 12 ranged between 5 seconds and 300 seconds.

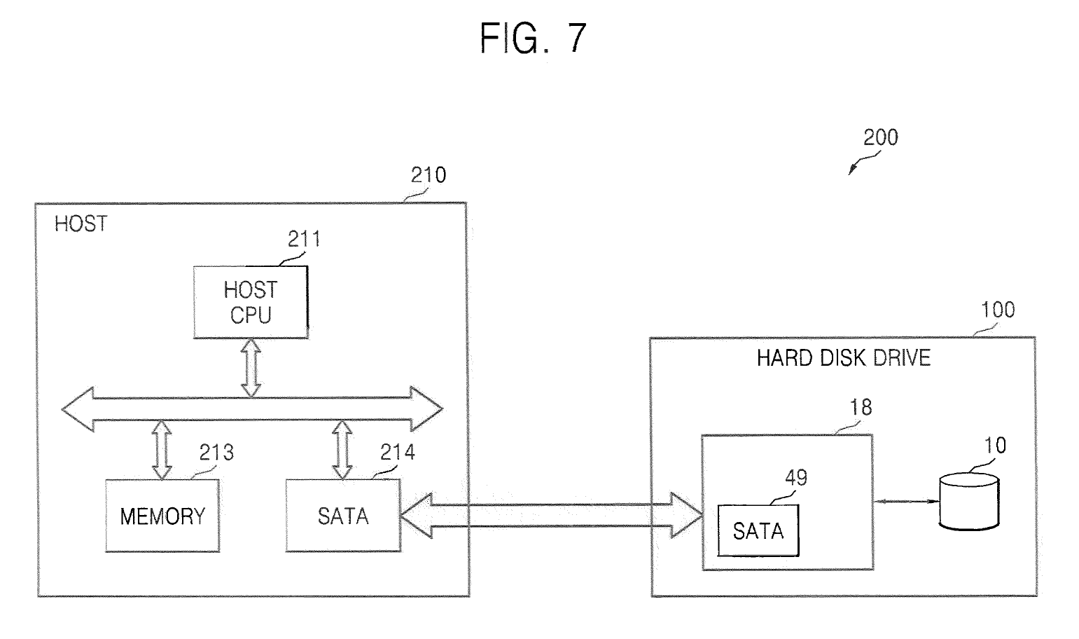

FIG. 7 is a block diagram of a computer system 200 including the HDD 100 of FIG. 1. Referring to FIG. 7, the computer system 200 includes the HDD 100 and a host 210 to exchange data with the HDD 100. Referring to FIGS. 1-7, the HDD 100 includes a plurality of disks 10, the heads 12, the VCM 40 to control the operations of the heads 12, and the VCM driver 36 to control the VCM 40, and a HDD interface 49. The VCM driver 36 controls the operation of the VCM 40 according to an unload standby time determined by the controller 22c included in the HDC 22.

The host 210 includes a host CPU 211, a memory 213, and a host interface 214. The host CPU 211 controls the operation of the host 210. During a write operation, the host CPU 211 may transmit data output from the memory 213 to a HDD interface 49 embodied on the circuit block 18 of the HDD 100 via the host interface 214. The host interface 214 and the HDD interface 49 may be embodied by a serial advanced technology attachment (SATA) interface. Thus, the host interface 214 and the HDD interface 49 may exchange data by using a SATA protocol.

During a read operation, the host interface 214 may store the data transmitted from the HDD interface 49 embodied on the circuit block 18 of the HDD 100 in the memory 213 under the control of the host CPU 211. The host CPU 211 may process the data stored in the memory 213, for example, by displaying the data using a display device or outputting the data using a peripheral device such as a printer connected to a universal serial bus (USB) port.

As described above, the hard disk control module according to the present general inventive concept and the method of controlling an unload standby time of the hard disk control module may count the number of loads/unloads of the head and control the unload standby time of the head according to a load/unload count value.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A hard disk controller comprising:
a load/unload counter to count a number of loads/unloads of a head above/from a surface of a disk; and
a controller to control an unload standby time of the head according to a load/unload count value for a reference time.

2. The hard disk controller of claim 1, wherein, when the load/unload count value is equal to or greater than a reference count value, the controller stops a load/unload operation of the head.

3. The hard disk controller of claim 1, wherein the controller compares the load/unload count value with a reference count value and controls the unload standby time according to a result of the comparison.

4. A hard disk drive comprising:
a hard disk;
a head;
a voice coil motor to control an operation of the head; and
a voice coil motor driver to control an operation of the voice coil motor according to the unload standby time controlled by the controller of the hard disk controller of claim 1.

5. The hard disk drive of claim 4, wherein the controller stops a load/unload operation of the head when the load/unload count value is equal to or greater than a reference count value.

6. The hard disk drive of claim 4, wherein the controller compares the load/unload count value with a reference count value and controls the unload standby time according to a result of the comparison.

7. A computer system comprising:
the hard disk drive of claim 4; and
a host for controlling an operation of the hard disk drive.

8. A method of controlling an unload standby time of a hard disk controller, the method comprising:
setting a reference time to count a number of loads/unloads of a head above/from a surface of a disk;
counting the number of loads/unloads of the head during the reference time; and
controlling the unload standby time of the head according to a load/unload count value.

9. The method of claim 8, wherein, the controlling the unload standby time of the head, when the load/unload count value is equal to or greater than a reference count value, a load/unload operation of the head is stopped.

10. The method of claim 8, wherein the controlling the unload standby time of the head comprises:
comparing the load/unload count value with a reference count value; and
controlling the unload standby time according to a result of the comparison.

11. A hard disk controller comprising:
a load/unload timer to measure a time interval during which a load/unload occurs whenever the load/unload of a head occurs for a reference time;
a load/unload counter to count a number of loads/unloads according to a measured time interval; and
a controller to set a first time interval having a first value and a second time interval having a second value, of load/unload count values counted for each time interval, and to determine an unload standby time using the determined first and second time intervals.

12. The hard disk controller of claim 11 wherein the first value is the largest load/unload count value of the counted load/unload count values and the second value is the largest value next to the first value, and the controller determines the unload standby time existing between the first and second time intervals

13. A hard disk drive comprising:
a hard disk;
a head;
a voice coil motor to control an operation of the head; and
a voice coil motor driver to control an operation of the voice coil motor according to the unload standby time controlled by the controller of the hard disk controller of 11.

14. The hard disk drive of claim 13, wherein the controller determines a first time interval having a first value and a second time interval having a second value, of load/unload count values counted during each time interval, and determines the unload standby time existing between the first and second time intervals.

15. A computer system comprising:
the hard disk drive of claim 13; and
a host to control an operation of the hard disk drive.
